(19) United States
(12) Patent Application Publication
(10) Pub. No.: US 2009/0299013 A1
(43) Pub. Date: Dec. 3, 2009

(54) Process for the Preparation of Star and Block-Copolymers Via Epoxy-Functionalized Alkoxyamines

(76) Inventors: Jochen Fink, Nussloch (DE); Rudolf Pfaendner, Rimbach (DE); Andreas Kramer, Meyriez (CH); Francesco Fuso, Therwil (CH)

Correspondence Address: JoAnn Villamizar;Ciba Corporation/Patent Department, 540 White Plains Road, P.O. Box 2005, Tarrytown, NY, 10591, US

(21) Appl. No.: 11/887,497

(22) PCT Filed: Mar. 27, 2006
(86) PCT No.: PCT/EP2006/061045

§ 371 Date: Aug. 5, 2009

(30) Foreign Application Priority Data
Apr. 4, 2005 (EP) 05102621.9

(51) Int. Cl. C08F 112/08; C08F 2/38

(52) U.S. Cl. 525/333.5; 525/343; 525/375; 525/377; 525/379; 525/384; 525/386; 525/333.3; 525/333.6

(57) ABSTRACT

The instant invention relates to a process for the preparation of star and block-copolymers, which are prepared by controlled free radical polymerization using epoxy-functionalized alkoxyamines and multifunctional compounds capable of reacting with the epoxy group.

The instant invention relates to a process for the preparation of star and block-copolymers, which are prepared by controlled free radical polymerization using epoxy-functionalized alkoxyamines and multifunctional compounds capable of reacting with the epoxy group.

Well-defined star polymers are typically prepared by various living polymerization techniques. There are three basic synthesis routes for star polymers. One is the so called core-first method, which uses a multifunctional initiator to initiate the polymerization of monomers, whereby the number of arms is determined by the number of initiating sites on the initiator molecule. This is for example described by J. Ueda, M. Kamigaito, M. Sawamoto; Macromolecules 31; 6762 (1998).

The arm-first technique involves the synthesis of preformed arms, usually through living polymerization, followed by reaction with a multifunctional linking agent as for example described by S. Kannaoka, M. Sawamoto, T. Higashimura; Macromolecules 24; 2309 (1991) and by R. T. A. Mayadunne, J. Jeffery, G. Moad, E. Rizzardo; Macromolecules 36; 1505 (2003).

The third method is a slight variation of the arm-first technique, which sometimes is also termed the “nodule” method. In this method, the reactive macroinitiator (arms) produced by a living polymerization technique are cross-linked by a divinyl reagent to form star polymers, as for example described by X. Zhang, J. H. Xia, K. Matyjaszewski; Macromolecules 33, 2340 (2000).

A further approach is the grafting of epoxy-terminated oligomers onto functionalized polymers leading also to star and comb-copolymers, as for example disclosed in WO 04/069887.

It has now been found that starting with epoxy-functional alkoxyamines it is possible to firstly polymerize ethylenically unsaturated monomers in a controlled way and thereby introducing the reactive epoxy group into the polymer backbone. In a second step the epoxy group can be reacted with selected multifunctional compounds in a polymer analogous reaction, giving finally highly branched star polymers. It is, however, also possible to firstly react the epoxy-functional alkoxyamines with a multifunctional compound thereby introducing branching in the first reaction step. As a second step controlled radical polymerization in the presence of an ethylenically unsaturated monomer can be carried out. In both cases a broad range of highly branched star polymers is accessible.

Star branched copolymers of narrow molecular weight distribution have unique rheological properties and behave significantly different from linear polymer melts. These differences in the mechanical and solubility properties are due to different dynamics of star (co)polymers compared to their linear counterparts. Star-shaped polymers may serve as surface-active agents, compatibilizers, thermoplastic elastomers, materials for shaping parts and emulsifiers.

One aspect of the invention is a method for the preparation of a star polymer or copolymer comprising

a1) polymerising in a first step an ethylenically unsaturated monomer in the presence of an initiator compound of formula (I)

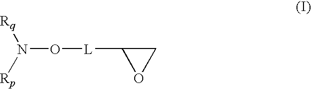

wherein L is a linking group selected from the group consisting of C₁-C₁₈alkylene, phenylene, phenylene-C₁-C₁₈alkylene, C₁-C₁₈alkylene-phenylene, C₁-C₁₈alkylene-phenylene-oxy and C₅-C₁₂cycloalkylene;

Rₚ and R_{q} are independently tertiary bound C₄-C₂₈alkyl groups which are unsubstituted or substituted by one or more electron withdrawing groups or by phenyl; or

Rₚ and R_{q} together form a 5 or 6 membered heterocyclic ring which is substituted at least by 4 C₁-C₄alkyl groups and which may be interrupted by a further nitrogen or oxygen atom; and in a second step

b1) reacting the polymer obtained in step a) with a compound of formula R₁(X)ₙ, wherein R₁ is C₁-C₂₄alkyl, C₅-C₁₂cycloalkyl, phenyl, naphthyl, C₇-C₁₅phenylalkyl or is the residue of a phosphor containing acid;

### X is OH, —COOH, —COCl, NH₂, —NHR,

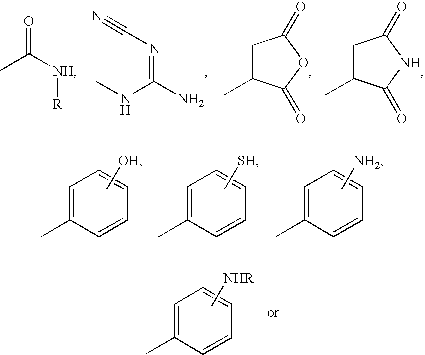

X is a radical derived from glycerol or from a polyvinylalcohol
R is C₁-C₂₄alkyl and n is a number from 3-10;
or
a2) reacting in a first step a compound of formula I with a compound of formula R(X)ₙ as defined above, and
b2) reacting the multifunctional initiator compound, obtained in step a2) with an ethylenically unsaturated monomer in a polymerization reaction.

For example the compound of formula (I) is of formula (II)

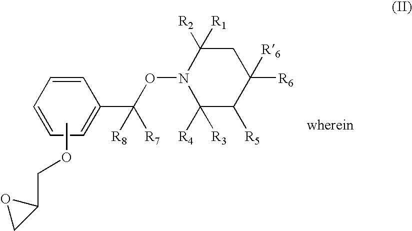

R₁, R₂, R₃ and R₄ are independently of each other C₁-C₄alkyl;
R₅ is hydrogen or C₁-C₄alkyl;
R′₆ is hydrogen and R₆ is H, OR₁₀, NR₁₀R₁₁, —O—C(O)—R₁₀ or NR₁₁—C(O)—R₁₀;
R₁₀ and R₁₁ independently are hydrogen, C₁-C₁₈alkyl, C₂-C₁₈alkenyl, C₂-C₁₈alkinyl or C₂-C₁₈alkyl which is substituted by at least one hydroxy group or, if R₆ is NR₁₀R₁₁, taken together, form a C₂-C₁₂alkylene bridge or a C₂-C₁₂-alkylene bridge interrupted by at least one O atom; or
R₆ and R′₆ together are both hydrogen, a group ═O or ═N—O—R₂₀ wherein
R₂₀ is H, straight or branched C₁-C₁₈alkyl, C₃-C₁₈alkenyl or C₃-C₁₈alkinyl, which may be unsubstituted or substitued, by one or more OH, C₁-C₈alkoxy, carboxy, C₁-C₈alkoxycarbonyl;
C₅-C₁₂cycloalkyl or C₅-C₁₂cycloalkenyl;
phenyl, C₇-C₉phenylalkyl or naphthyl which may be unsubstituted or substituted by one or more C₁-C₈alkyl, halogen, OH, C₁-C₈alkoxy, carboxy, C₁-C₈alkoxycarbonyl;
—C(O)—C₁-C₃₆alkyl, or an acyl moiety of a α,β-unsaturated carboxylic acid having 3 to 5 carbon atoms or of an aromatic carboxylic acid having 7 to 15 carbon atoms;
—SO₃⁻Q⁺, —PO(O⁻Q⁺)₂, —P(O)(OR₂)₂, —SO₂—R₂, —CO—NH—R₂, —CONH₂, COOR₂, or Si(Me)₃, wherein Q⁺ is H⁺, ammonium or an alkali metal cation; or
R₆ and R₆′ are independently —O—C₁-C₁₂alkyl, —O—C₃-C₁₂alkenyl, —O—C₃-C₁₂alkinyl, —O—C₅-C₈cycloalkyl, —O-phenyl, —O-naphthyl, —O—C₇-C₉phenylalkyl; or
R₆ and R′₆together form one of the bivalent groups —O—C(R₂₁)(R₂₂)—CH(R₂₃)—O—, —O—CH(R₂₁)—CH₂₂—C(R₂₂)(R₂₃)—O—, —O—CH(R₂₂)—CH₂—C(R₂₁)(R₂₃)—O—, —O—CH₂—C(R₂₁)(R₂₂)—CH(R₂₃)—O—, —O-o-phenylene-O—, —O-1,2-cyclohexyliden-O—, —O—CH₂—CH═CH—CH₂—O— or

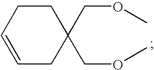

wherein
R₂₁ is hydrogen, C₁-C₁₂alkyl, COOH, COO—(C₁-C₁₂)alkyl or CH₂OR₂₄;
R₂₂ and R₂₃ are independently hydrogen, methyl ethyl, COOH or COO—(C₁-C₁₂)alkyl;
R₂₄ is hydrogen, C₁-C₁₂alkyl, benzyl, or a monovalent acyl residue derived from an aliphatic, cycloaliphatic or aromatic monocarboxylic acid having up to 18 carbon atoms; and
R₇ and R₈ are independently hydrogen or C₁-C₁₈alkyl.

C₁-C₁₈alkyl can be linear or branched. Examples are methyl, ethyl, propyl, isopropyl, butyl, 2-butyl, isobutyl, t-butyl, pentyl, 2-pentyl, hexyl, heptyl, octyl, 2-ethylhexyl, t-octyl, nonyl, decyl, undecyl, dodecyl or octadecyl. Where up to C₃₆alkyl is possible, C₁-C₁₈alkyl is preferred.

Alkyl substituted by a group —COOH is for example CH₂—COOH, CH₂—CH₂—COOH, (CH₂)₃—COOH or CH₂—CHCOOH—CH₂—CH₃

Hydroxyl- or alkoxycarbonyl substituted C₁-C₁₈alkyl can be, for example, 2-hydroxyethyl, 2-hydroxypropyl, methoxycarbonylmethyl or 2-ethoxycarbonylethyl.

Alkenyl having from 2 to 18 carbon atoms is a branched or unbranched radical, for example propenyl, 2-butenyl, 3-butenyl, isobutenyl, n-2,4-pentadienyl, 3-methyl-2-butenyl, n-2-octenyl, n-2-dodecenyl, isododecenyl.

Alkinyl having from 2 to 18 carbon atoms is a branched or unbranched radical, for example propinyl, 2-butinyl, 3-butinyl, isobutinyl, n-2,4-pentadiinyl, 3-methyl-2-butinyl, n-2-octinyl, n-2-dodecinyl, isododecinyl.

Examples of alkoxy are methoxy, ethoxy, propoxy, isopropoxy, butoxy, isobutoxy, pentoxy, isopentoxy, hexoxy, heptoxy or octoxy.

C₇-C₉-phenylalkyl is for example benzyl, α-methylbenzyl, α,α-dimethylbenzyl or 2-phenylethyl, benzyl is preferred.

C₅-C₁₂cycloalkyl is for example cyclopentyl, cyclohexyl, cycloheptyl, methylcyclopentyl or cyclooctyl.

C₅-C₁₂cycloalkenyl is for example 3-cyclopentenyl, 3-cyclohexenyl or 3-cycloheptenyl.

Examples of a monocarboxylic acid having up to 18 carbon atoms are formic acid, acetic acid, propionic acid, the isomers of valeric acid, methyl ethyl acetic acid, trimethyl acetic acid, capronic acid, lauric acid or stearic acid. Examples for unsaturated aliphatic acids are acrylic acid, methacrylic acid, crotonic acid, linolic acid and oleic acid.

Typical examples of cycloaliphatic carboxylic acids are cyclohexane carboxylic acid or cyclopentane carboxylic acid.

Examples of aromatic carboxylic acids are benzoic acid, salicylic acid or cinnamic acid.

Halogen is F, Cl, Br or I.

C₁-C₁₈alkylene is a branched or unbranched radical, for example methylene, ethylene, propylene, trimethylene, tetramethylene, pentamethylene, hexamethylene, heptamethylene, octamethylene, decamethylene or dodecamethylene.

C₂-C₁₂alkylene bridges interrupted by at least one O atom are, for example, —CH₂—O—CH₂—CH₂, —CH₂—O—CH₂—CH₂—CH₂, —CH₂—O—CH₂—CH₂—CH₂—CH₂—, —CH₂—O—CH₂—CH₂—O—CH₂—.

Alkoxycarbonyl is for example methoxycarbonyl, ethoxycarbonyl, propoxycarbonyl.

For instance R₁, R₂, R₃, R₄ are methyl, or R₁ and R₃ are ethyl and R₂ and R₄ are methyl, or R₁ and R₂ are ethyl and R₃ and R₄ are methyl.

For example R₅ is hydrogen or methyl.

Preferably R′₆ is hydrogen and R₆ is H, OR₁₀, NR₁₀R₁₁, —O—C(O)—R₁₀ or NR₁₁—C(O)—R₁₀;

R₁₀ and R₁₁ independently are hydrogen, C₁-C₁₈alkyl, C₂-C₁₈alkenyl, C₂-C₁₈alkinyl or C₂-C₁₈alkyl which is substituted by at least one hydroxy group or, if R₆ is NR₁₀R₁₁, taken together, form a C₂-C₁₂alkylene bridge or a C₂-C₁₂-alkylene bridge interrupted by at least one O atom; or
R₆ and R′₆ together are both hydrogen, a group ═O or ═N—O—R₂₀ wherein
R₂₀ is H or straight or branched C₁-C₁₈alkyl.

In another preferred embodiment R₆ and R′₆ together form one of the bivalent groups —O—C(R₂₁)(R₂₂)—CH(R₂₃)—O—, —O—CH(R₂₁)—CH₂₂—C(R₂₂)(R₂₃)—O—, —O—CH(R₂₂)—CH₂—C(R₂₁)(R₂₃)—O—, —O—CH₂—C(R₂₁)(R₂₂)—CH(R₂₃)—O— and R₂₁, R₂₂ and R₂₃ have the meaning as defined above.

Specific compounds are given in Table A

TABLE A

| Compound Number | Structure |
|---|---|
| 101 | 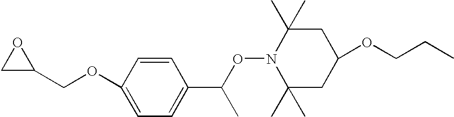 |
| 102 | 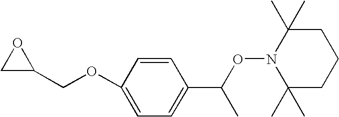 |
| 103 | 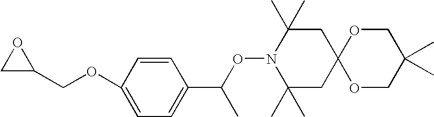 |
| 104 | 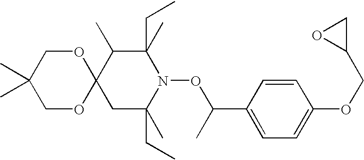 |
| 105 | 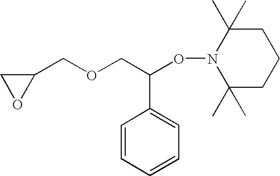 |

The compounds of formula II and in particular the compounds given in Table A are known and may be prepared as described in WO 99/46261, WO 02/48109 or U.S. Pat. No. 5,721,320.

For example the ethylenically unsaturated monomer or oligomer is selected from the group consisting of styrene, substituted styrene, conjugated dienes, vinyl acetate, vinylpyrrolidone, vinylimidazole, maleic anhydride, (alkyl)acrylic acidanhydrides, (alkyl)acrylic acid salts, (alkyl)acrylic esters, (meth)acrylonitriles, (alkyl)acrylamides, vinyl halides and vinylidene halides.

In particular the ethylenically unsaturated monomers are styrene, methylacrylate, ethyl-acrylate, butylacrylate, isobutylacrylate, tert. butylacrylate, hydroxyethylacrylate, hydroxy-propylacrylate, dimethylaminoethylacrylate, methyl(meth)acrylate, ethyl(meth)acrylate, butyl(meth)acrylate, hydroxyethyl(meth)acrylate, hydroxypropyl(meth)acrylate, dimethyl-aminoethyl(meth)acrylate, acrylonitrile, acrylamide, methacrylamide or dimethylaminopropyl-methacrylamide.

Particularly the ethylenically unsaturated monomers are isoprene, 1,3-butadiene, α-C₅-C₁₈alkene, styrene, α-methyl styrene, p-methyl styrene or a compound of formula CH₂═C(Rₐ)—(C=Z)—R_{b}, wherein Rₐ is hydrogen or C₁-C₄alkyl, R_{b} is NH₂, O⁻(Me⁺), glycidyl, unsubstituted C₁-C₁₈alkoxy, C₂-C₁₀₀alkoxy interrupted by at least one N and/or O atom, or hydroxy-substituted C₁-C₁₈alkoxy, unsubstituted C₁-C₁₈alkylamino, di(C₁-C₁₈alkyl)amino, hydroxy-substituted C₁-C₁₈alkylamino or hydroxy-substituted di(C₁-C₁₈alkyl)amino, —O—CH₂—CH₂—N(CH₃)₂ or —O—CH₂—CH₂—N⁺H(CH₃)₂ An⁻;

An⁻ is a anion of a monovalent organic or inorganic acid;
Me is a monovalent metal atom or the ammonium ion.
Z is oxygen or sulfur.

Examples for Rₐ as C₂-C₁₀₀alkoxy interrupted by at least one O atom are of formula

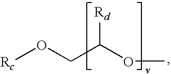

wherein R_{c} is C₁-C₂₅alkyl, phenyl or phenyl substituted by C₁-C₁₈alkyl, R_{d} is hydrogen or methyl and v is a number from 1 to 50. These monomers are for example derived from non ionic surfactants by acrylation of the corresponding alkoxylated alcohols or phenols. The repeating units may be derived from ethylene oxide, propylene oxide or mixtures of both.

Further examples of suitable acrylate or methacrylate monomers are given below.

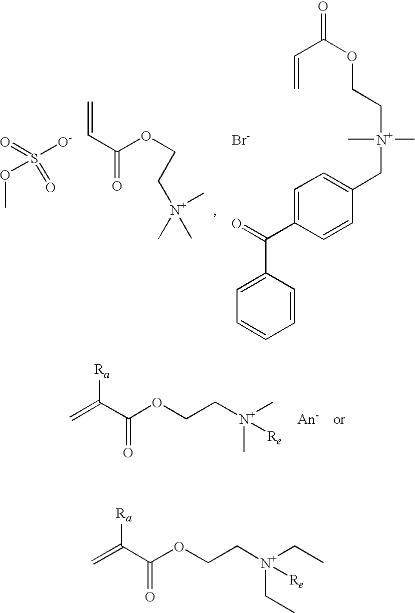

An⁻, wherein An⁻ and Rₐ have the meaning as defined above and Rₑ is methyl, benzyl or benzoylbenzyl. An⁻ is preferably Cl⁻, Br⁻ or ⁻O₃S—O—CH₃.

Further acrylate monomers are N

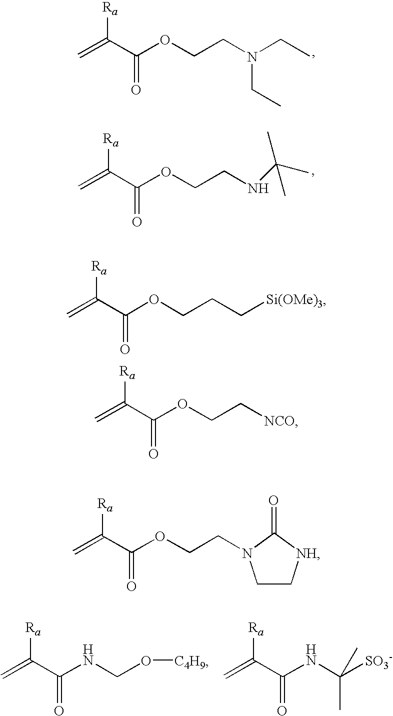

Me⁺, Me⁺ is an alkali metal cation or the ammonium cation.

Examples for suitable monomers other than acrylates are

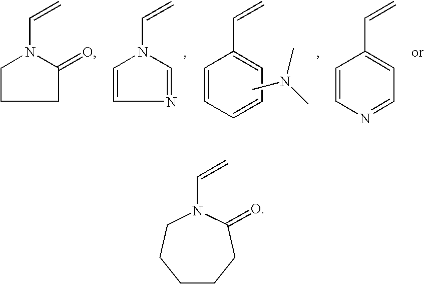

Preferably Rₐ is hydrogen or methyl, R_{b} is NH₂, gycidyl, unsubstituted or with hydroxy substituted C₁-C₄alkoxy, unsubstituted C₁-C₄alkylamino, di(C₁-C₄alkyl)amino, hydroxy-substituted C₁-C₄alkylamino or hydroxy-substituted di(C₁-C₄alkyl)amino; and

Z is oxygen.

For example in the compound of formula R₁ (X)ₙ R₁ is C₁-C₁₂alkyl, C₅-C₁₂cycloalkyl or phenyl;

### X is OH, —COOH, —COCl, NH₂, —NHR,

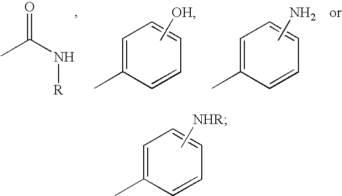

R is C₁-C₁₂alkyl and n is a number from 3-6.

Particularly useful are the following compounds R₁(X)ₙ:

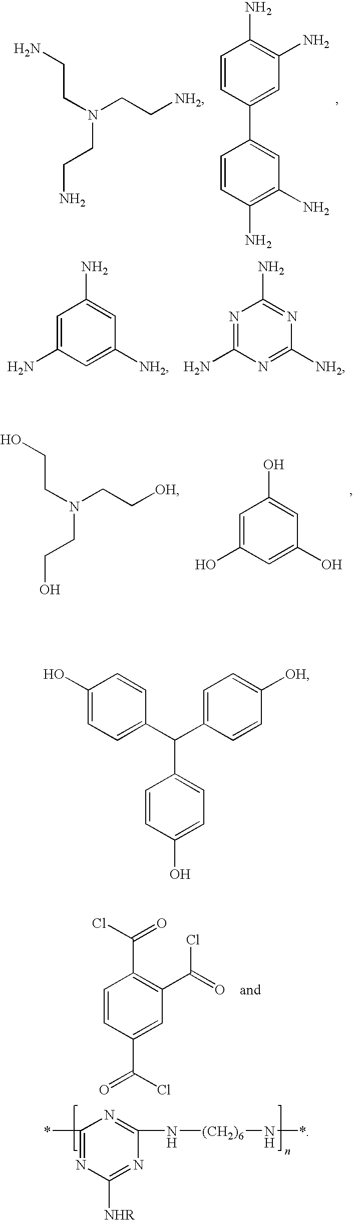

For example the reaction steps a2) and b1) are carried out at a temperature between 20° C. and 120° C.

The coupling steps (a2, b1) between epoxy-functionalized NOR or epoxy-functionalized/NO-terminated-oligomer, cooligomer, polymer or copolymer and the multifunctional compound can be carried out in bulk or solution, containing 10-90% (by vol.) solvent. Suitable solvents include tetrahydrofurane, benzene, toluene, acetonitrile, dimethylformamide, chlorinated solvents and mixtures thereof.

Preferably the temperature of the coupling steps is between 50° C.-120° C., more preferably between 60° C.-110° C. and most preferably between 70° C.-100° C.

Preferably the coupling step is carried out at a temperature below the cleavage temperature of the NOR bond, where polymerization is initiated. This cleavage temperature depends on the structure of the selected NOR compound. For example the tetramethyl piperidines given in Table A can be processed at higher temperatures as compared to the dimethyl, diethyl substituted compound no. 104.

Typical reaction times range from 1-72 h, more preferably 1-48 h and most preferably from 3-24 h.

The reaction is usually carried out under atmospheric pressure.

The isolation of the star copolymer depends on its molecular structure. Residual monomers can be removed in vacuo at temperatures not exceeding 100° C. It is also possible to precipitate the polymer or to extract residual monomers with appropriate solvents.

Preferably the reaction steps a1) and b2) are carried out at a temperature between 80° and 160° C.

As already mentioned the alkoxyamine bond cleaves at elevated temperature and radical polymerization is initiated. Preferably the polymerization temperature is from 80° C. to 140° C., in particular from 100° C. to 140° C.

For example in step a1) the compound of formula I is present in an amount from 0.01 to 10 mol % based on the molar amount of the ethylenically unsaturated monomer.

For instance in step b2) the reaction product of step a2) is present in an amount from 0.01 to 10 mol % based on the molar amount of the ethylenically unsaturated monomer.

Typically the average weight molecular weight M_{W} of the star polymer or copolymer is from 1000 to 300 000, preferably from 3000 bis 100000.

The polydispersity index of the resulting comb or star copolymer is typically between 1.1 and 3.0.

Because the polymerization of step b) is a “quasi living” polymerization, it can be started and stopped practically at will. Furthermore, the polymer product retains the functional alkoxyamine group allowing a continuation of the polymerization in a living matter. Thus, in one embodiment of this invention, once the first monomer is consumed in the initial radical polymerizing step a second monomer can then be added to form a second block on the growing polymer chain in a second polymerization step. Therefore it is possible to carry out additional polymerizations with the same or different monomer(s) to prepare multi-block copolymers.

Furthermore, since this is a “quasi living” radical polymerization, blocks can be prepared in essentially any order. One is not necessarily restricted to preparing block copolymers where the sequential polymerizing steps must flow from the least stabilized polymer intermediate to the most stabilized polymer intermediate, such as is the case in ionic polymerization. Thus it is possible to prepare a multi-block copolymer in which a polyacrylonitrile or a poly(meth)-acrylate block is prepared first, then a styrene or butadiene block is attached thereto, and so on.

Random copolymers and tapered copolymer structures can be synthesized as well by using a mixture of monomers or adding a second monomer before the first one is completely consumed.

A further aspect of the invention is a star polymer or copolymer obtainable in a method as described above.

Yet another aspect of the invention is the use of a star polymer or copolymer obtainable according to the method described above as crosslinking agent, ionomer, emulsifier, adhesive, surface modifier, surfactant or compatibilizer in thermoplastic, elastic or thermosetting polymers or as plastic material for extrusion or injection molding for shaping parts.

The following examples illustrate the invention.

### General Remarks:

Solvents and monomers are distilled over a Vigreux column under argon atmosphere or under vacuum, shortly before being used.

To remove oxygen all polymerization reaction mixtures are flushed before polymerization with argon and evacuated under vacuum applying a freeze-thaw cycle. The reaction mixtures are then polymerized under argon atmosphere.

At the start of the polymerization reaction, all starting materials are homogeneously dissolved.

Conversion is determined by removing unreacted monomers from the polymer by precipitation in methanol and/or by drying in vacuo (0.002 torr) at least 60 minutes, weighing the remaining polymer and subtract the weight of the initiator.

Characterization of the polymers is carried out by GPC (Gel Permeation Chromatography). GPC: Is performed using RHEOS 4000 of FLUX INSTRUMENTS. Tetrahydrofurane (THF) is used as a solvent and is pumped at 1 ml/min. Two chromatography columns are put in series: type PIgel 5 μm mixed-C of POLYMER INSTRUMENTS, Shropshire, UK. Measurements are performed at 40° C. The columns are calibrated with low polydispersity polystyrenes having Mn from 200 to 2 000 000 Dalton. Detection is carried out using a RI-Detector ERC-7515A of ERCATECH AG at 30° C.

1H-NMR is performed using a BRUKER AVANCE 200.

Compound 103

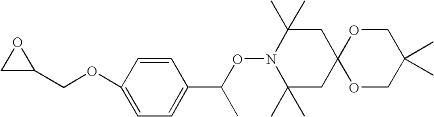

has been prepared according to WO 02/48109.
Preparation of a Star Polymer with Polystyrene Side Arms
Two step reaction:
1^{st} step: Synthesis of multifunctional initiator compound
2^{nd} step: CFRP with styrene to prepare a star polymer
1^{st} step: Reaction Between Tris(2-aminomethyl)amine and Compound 103

In a dry, Argon-purged Schlenk tube equipped with a rubber septum, a magnetic stir bar and an Argon inlet, 0.618 g (0.00423 mol) tris(2-aminomethyl)amine and 5,502 g (0,01269 mol) compound 103 are dissolved in 15 ml dry toluene. The solution is heated at 90° C. for 9 h. After cooling down at room temperature the solvent is removed in vacuo and the resulting compound is dried overnight in vacuo at 50° C. until weight constant.

The multifunctional initiator compound A is obtained as slight yellow solid in quantitative yield

¹H-NMR: no further epoxy-groups in the spectra confirms the complete reaction of the epoxy-functionalized NOR with the triamine.

2^{nd} step: Reinitiation of Multifunctional Initiator Compound A with Styrene

In a dry, Argon-purged Schienk tube equipped with a rubber septum, a magnetic stir bar and an Argon inlet, 2,5 g compound A is dissolved in 90 g (0,864 mol) styrene. The solution is heated at 130° C. for 6 h. After cooling down at room temperature the residual monomer (styrene) is removed in vacuo and the resulting star polymer is dried overnight in vacuo at 50° C. until constant weight.

The star polymer is obtained as white solid with a conversion of 55%.

| | Conv. | | | | |
|---|---|---|---|---|---|
| Comp. | [%] | Mn | Mw | Mp | Mw/Mn |
| Star polymer | 55 | 6500 | 12000 | 10300 | 1.8 |

1. A method for the preparation of a star polymer or copolymer comprising
a1) polymerising in a first step an ethylenically unsaturated monomer in the presence of an initiator compound of formula (I) 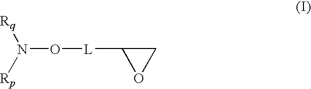
wherein L is a linking group selected from the group consisting of C₁-C₁₈alkylene, phenylene, phenylene-C₁-C₁₈alkylene, C₁-C₁₈alkylene-phenylene, C₁-C₁₈alkylene-phenylene-oxy and C₅-C₁₂cycloalkylene; and
Rₚ and R_{q} are independently tertiary bound C₄-C₂₈alkyl groups which are unsubstituted or substituted by one or more electron withdrawing groups or by phenyl; or
Rₚ and R_{q} together form a 5 or 6 membered heterocyclic ring which is substituted at least by 4 C₁-C₄alkyl groups and which may be interrupted by a further nitrogen or oxygen atom;
and in a second step
b1) reacting the polymer obtained in step a1) with a compound of formula R₁ (X)ₙ, wherein R₁ is C₁-C₂₄alkyl, C₅-C₁₂cycloalkyl, phenyl, naphthyl or C₇-C₁₅phenylalkyl or is the residue of a phosphor containing acid;
X is OH, —COOH, —COCl, NH₂, —NHR, 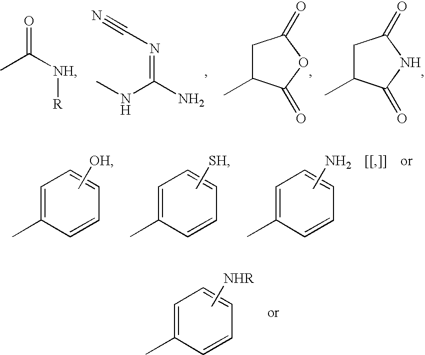
X is a radical derived from glycerol or from a polyvinylalcohol; and
R is C₁-C₂₄alkyl and n is a number from 3-10;
or
a2) reacting in a first step a compound of formula I with a compound of formula R(X)ₙ as defined above, and
b2) reacting the multifunctional initiator compound, obtained in step a2) with an ethylenically unsaturated monomer in a polymerization reaction.

2. A method according to claim 1 wherein the initiator compound is of formula (II) 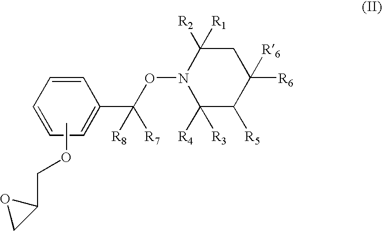
wherein
R₁, R₂, R₃ and R₄ are independently of each other C₁-C₄alkyl;
R₅ is hydrogen or C₁-C₄alkyl;
R′₆ is hydrogen and R₆ is H, OR₁₀, NR₁₀R₁₁, —O—C(O)—R₁₀ or NR₁₁—C(O)—R₁₀;
R₁₀ and R₁₁ independently are hydrogen, C₁-C₁₈alkyl, C₂-C₁₈alkenyl, C₂-C₁₈alkinyl or C₂-C₁₈alkyl which is substituted by at least one hydroxy group or, if R₆ is NR₁₀R₁₁, taken together, form a C₂-C₁₂alkylene bridge or a C₂-C₁₂-alkylene bridge interrupted by at least one O atom; or
R₆ and R′₆ together are a group ═O or ═N—O—R₂₀ wherein
R₂₀ is H, straight or branched C₁-C₁₈alkyl, C₃-C₁₈alkenyl or C₃-C₁₈alkinyl, which may be unsubstituted or substituted by one or more OH, C₁-C₈alkoxy, carboxy or C₁-C₈alkoxycarbonyl;
C₅-C₁₂cycloalkyl or C₅-C₁₂cycloalkenyl;
phenyl, C₇-C₉phenylalkyl or naphthyl which may be unsubstituted or substituted by one or more C₁-C₈alkyl, halogen, OH, C₁-C₈alkoxy, carboxy or
C₁-C₈alkoxycarbonyl;
—C(O)—C₁-C₃₆alkyl or an acyl moiety of a α,β-unsaturated carboxylic acid having 3 to 5 carbon atoms or of an aromatic carboxylic acid having 7 to 15 carbon atoms;
—SO₃⁻Q⁺, —PO(O⁻Q⁺)₂, —P(O)(OR₂)₂, —SO₂—R₂, —CO—NH—R₂, —CONH₂, COOR₂, or Si(Me)₃, wherein Q⁺ is H⁺, ammonium or an alkali metal cation; or
R₆ and R₆′ are independently —O—C₁-C₁₂alkyl, —O—C₃-C₁₂alkenyl, —O—C₃-C₁₂alkinyl, —O—C₅-C₈cycloalkyl, —O-phenyl, —O-naphthyl or —O—C₇-C₉phenylalkyl; or
R₆ and R′₆ together form one of the bivalent groups —O—C(R₂₁)(R₂₂)—CH(R₂₃)—O—, —O—CH(R₂₁)—CH₂₂—C(R₂₂)(R₂₃)—O—, —O—CH(R₂₂)—CH₂—C(R₂₁)(R₂₃)—O—, —O—CH₂—C(R₂₁)(R₂₂)—CH(R₂₃)—O—, —O-o-phenylene-O—, —O—1,2-cyclohexyliden-O—,
—O—CH₂—CH═CH—CH₂—O— or 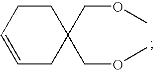
wherein
R₂₁ is hydrogen, C₁-C₁₂alkyl, COOH, COO—(C₁-C₁₂)alkyl or CH₂OR₂₄;
R₂₂ and R₂₃ are independently hydrogen, methyl, ethyl, COOH or COO—(C₁-C₁₂)alkyl;
R₂₄ is hydrogen, C₁-C₁₂alkyl, benzyl, or a monovalent acyl residue derived from an aliphatic, cycloaliphatic or aromatic monocarboxylic acid having up to 18 carbon atoms; and
R₇ and R₈ are independently hydrogen or C₁-C₁₈alkyl.

3. A method according to claim 2 wherein R₁, R₂, R₃, R₄ are methyl, or R₁ and R₃ are ethyl and R₂ and R₄ are methyl, or R₁ and R₂ are ethyl and R₃ and R₄ are methyl.

4. A method according to claim 2 wherein R₅ is hydrogen or methyl.

5. A method according to claim 2 wherein
R′₆ is hydrogen and R₆ is H, OR₁₀, NR₁₀R₁₁, —O—C(O)—R₁₀ or NR₁₁—C(O)—R₁₀;
R₁₀ and R₁₁ independently are hydrogen, C₁-C₁₈alkyl, C₂-C₁₈alkenyl, C₂-C₁₈alkinyl or C₂-C₁₈alkyl which is substituted by at least one hydroxy group or, if R₆ is NR₁₀R₁₁, taken together, form a C₂-C₁₂alkylene bridge or a C₂-C₁₂-alkylene bridge interrupted by at least one O atom; or
R₆ and R′₆ together are a group ═O or ═N—O—R₂₀ wherein
R₂₀ is H or straight or branched C₁-C₁₈alkyl.

6. A method according to claim 2 wherein
R₆ and R′₆ together form one of the bivalent groups —O—C(R₂₁)(R₂₂)—CH(R₂₃)—O—, —O—CH(R₂₁)—CH₂₂—C(R₂₂)(R₂₃)—O—, —O—CH(R₂₂)—CH₂—C(R₂₁)(R₂₃)—O— or —O—CH₂—C(R₂₁)(R₂₂)—CH(R₂₃)—O—.

7. A method according to claim 1 wherein the ethylenically unsaturated monomer is selected from the group consisting of styrene, substituted styrene, conjugated dienes, vinyl acetate, vinylpyrrolidone, vinylimidazole, maleic anhydride, (alkyl)acrylic acidanhydrides, (alkyl)acrylic acid salts, (alkyl)acrylic esters, (meth)acrylonitriles, (alkyl)acrylamides, vinyl halides and vinylidene halides.

8. A method according to claim 7 wherein the ethylenically unsaturated monomers are styrene, methylacrylate, ethylacrylate, butylacrylate, isobutylacrylate, tert-butylacrylate, hydroxyethylacrylate, hydroxypropylacrylate, dimethylaminoethylacrylate, methyl(meth)acrylate, ethyl(meth)acrylate, butyl(meth)acrylate, hydroxyethyl(meth)acrylate, hydroxypropyl(meth)acrylate, dimethylaminoethyl(meth)acrylate, acrylonitrile, acrylamide, methacrylamide or dimethylaminopropyl-methacrylamide.

9. A method according to claim 1 wherein in the compound of formula R₁(X)ₙ R₁ is C₁-C₁₂alkyl, C₅-C₁₂cycloalkyl or phenyl;
X is OH, —COOH, —COCl, NH₂, —NHR, 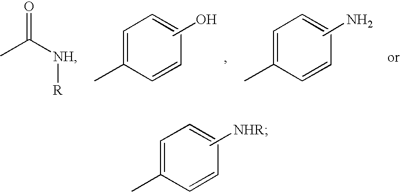
R is C₁-C₁₂alkyl and
n is a number from 3-6.

10. A method according to claim 1 wherein the reaction steps a2) and b1) are carried out at a temperature between 20° C. and 120° C.

11. A method according to claim 1 wherein the reaction steps a1) and b2) are carried out at a temperature between 80° and 160° C.

12. A method according to claim 1 wherein in step a1) the compound of formula I is present in an amount from 0.01 to 10 mol % based on the molar amount of the ethylenically unsaturated monomer.

13. A method according to claim 1 wherein in step b2) the reaction product of step a2) is present in an amount from 0.01 to 10 mol % based on the molar amount of the ethylenically unsaturated monomer.

14. A star polymer or copolymer obtained in a process according to claim 1.

15. (canceled)
